(19) United States
(12) Patent Application Publication
(10) Pub. No.: US 2012/0117184 A1
(43) Pub. Date: May 10, 2012

(54) Accessing Android Media Resources from Sony Dash

(76) Inventors: Aixin Liu, San Diego, CA (US); Shuo Chen, Los Angeles, CA (US); Djung Nguyen, San Diego, CA (US); Abhishek Patil, San Diego, CA (US)

(21) Appl. No.: 13/100,448

(22) Filed: May 4, 2011

Related U.S. Application Data
(60) Provisional application No. 61/411,123, filed on Nov. 8, 2010.

(51) Int. Cl. G06F 15/16

(52) U.S. Cl. 709/217

(57) ABSTRACT

A process of accessing media resources on Android capable wireless devices running an i-jetty HTTP server from a personal Internet interface device such as the Sony Dash. Activating a servlet on the Android device to transmit an IP address to a Dash capable device and establishing a wireless communication connection from the Dash device to the Android device using the IP address. Operating a service on the Dash device that accesses multimedia resources on the Android device where the Android device dynamically generates multimedia metadata for extraction and display on the Dash device. This abstract is not to be considered limiting, since other embodiments may deviate from the features described in this abstract.

### CROSS REFERENCE TO RELATED DOCUMENTS

This application is related to and claims priority benefit of U.S. Provisional Patent Application No. 61/411,123 filed Nov. 8, 2010 which is hereby incorporated by reference.

### COPYRIGHT AND TRADEMARK NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever. Trademarks are the property of their respective owners.

### BACKGROUND

The proliferation of the Android open system platform has resulted in a proliferation of Android based devices. However, Android has not been universally adopted.

### BRIEF DESCRIPTION OF THE DRAWINGS

Certain illustrative embodiments illustrating organization and method of operation, together with objects and advantages may be best understood by reference detailed description that follows taken in conjunction with the accompanying drawings in which:

FIG. 1 is a diagram of an exemplary system configuration diagram consistent with certain embodiments of the present invention.

FIG. 2 is a diagram of an exemplary communication and connectivity mapping diagram consistent with certain embodiments of the present invention.

FIG. 3 is a flow diagram depicting an example process for accessing android media resources consistent with certain embodiments of the present invention.

FIG. 4, is a flow chart depicting an exemplary process of the retrieval of metadata and content for presentation to a user on the display of a mobile device having an Internet viewer client installed on the device.

### DETAILED DESCRIPTION

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings.

The terms “a” or “an”, as used herein, are defined as one, or more than one. The term “plurality”, as used herein, is defined as two, or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically. The term “program” or “computer program” or similar terms, as used herein, is defined as a sequence of instructions designed for execution on a computer system. A “program”, or “computer program”, or “application” or “app” or the like may include a subroutine, a function, a procedure, an object method, an object implementation, in an executable application, an applet, a servlet, a script, a program module, a source code, an object code, a shared library/dynamic load library and/or other sequence of instructions designed for execution on a computer system.

Reference throughout this document to “one embodiment”, “certain embodiments”, “an embodiment” or similar terms means that a particular feature, structure, or characteristic described in connection with the embodiment is included in at least one embodiment of the present invention. Thus, the appearances of such phrases in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Content may be embodied as any or all audio, video, multimedia or interactive data that may be encoded with entertainment, training, artistic, textual, or experimental subject matter that is created for playback in modes such as compact disc (CD), digital versatile disc (DVD), high definition DVD (HD-DVD), Blu-ray Disc (BD) of any suitable format, tape, Internet streams or downloads, handheld players, computer storage media or any other suitable playable modes.

The proliferation of the Android open system platform has resulted in a proliferation of Android based devices. However, Android has not been universally adopted. Currently there are no known solutions for the problem of transfer of multimedia files or other content from an Android based device to devices such as Sony Corporation's Dash™ personal Internet viewer. In implementations consistent with certain embodiments of the present invention, an application referred to herein as “AnDash” solves this problem by allowing the Dash personal Internet viewer to retrieve media resources from a HyperText Transfer Protocol (HTTP) server on an Android based device. Dash applications (apps) are created using standard Adobe Flash development tools, published to run using Adobe Flash Lite 3.1. Developers of Dash applications will only need to follow some basic development/configuration parameters in order to optimize the applications for the Dash personal Internet viewer.

In the exemplary implementation, on the Android device side, an HTTP server is instantiated on the Android device, together with Java Servlet, which dynamically generates and sends Extensible Markup Language (XML) files containing multimedia metadata to the Dash personal Internet viewer through a wireless network. On the client side, the AnDash feature is added to the control panel, which is responsible for parsing the XML files, extracting metadata such as Universal Resource Locator (URL) and other location and control information, and playing back media files as well as sending an HTTP response back to the Android device.

The AnDash application enables Dash users to access media resources on Android based devices. AnDash broadens the content sources for Dash and enhances the capability of Dash as a Personal Internet Media Viewer. Moreover, based on this framework connecting the Dash with an Android device will open new opportunities to stimulate broader and more appealing applications for Dash. By way of example, an additional application could be utilizing a cellular network on Android phone from Dash. Media resources become readily accessible from Dash through an Android device upon installation of the AnDash solution.

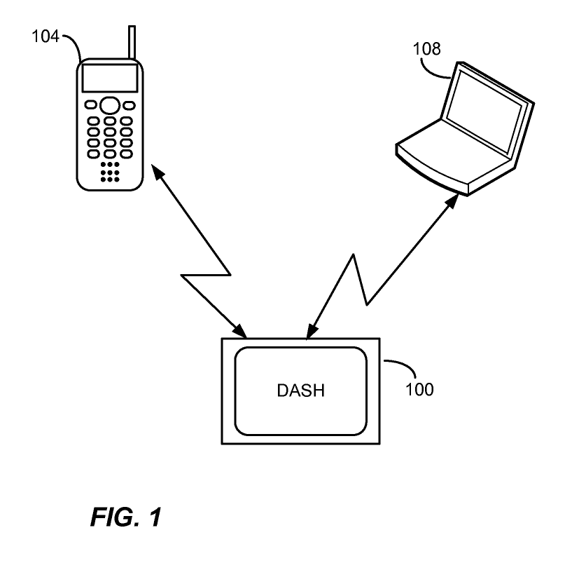

Turning now to FIG. 1, consistent with certain embodiments of the invention this figure presents an exemplary view of one possible system configuration for accessing android media resources from a personal Internet interface device. In this exemplary configuration, one or more Android capable devices may be placed in communication with the personal Internet interface device. In this example, a personal Internet interface device is a Dash capable device 100 manufactured by Sony Corporation. The Dash device 100 is in wireless communication with one or more Android capable devices as represented by an Android capable phone 104 and an Android capable laptop 108. The Dash device 100 may create and operate a wireless communication connection with either or both of the Android capable devices here represented using any suitable wireless interface.

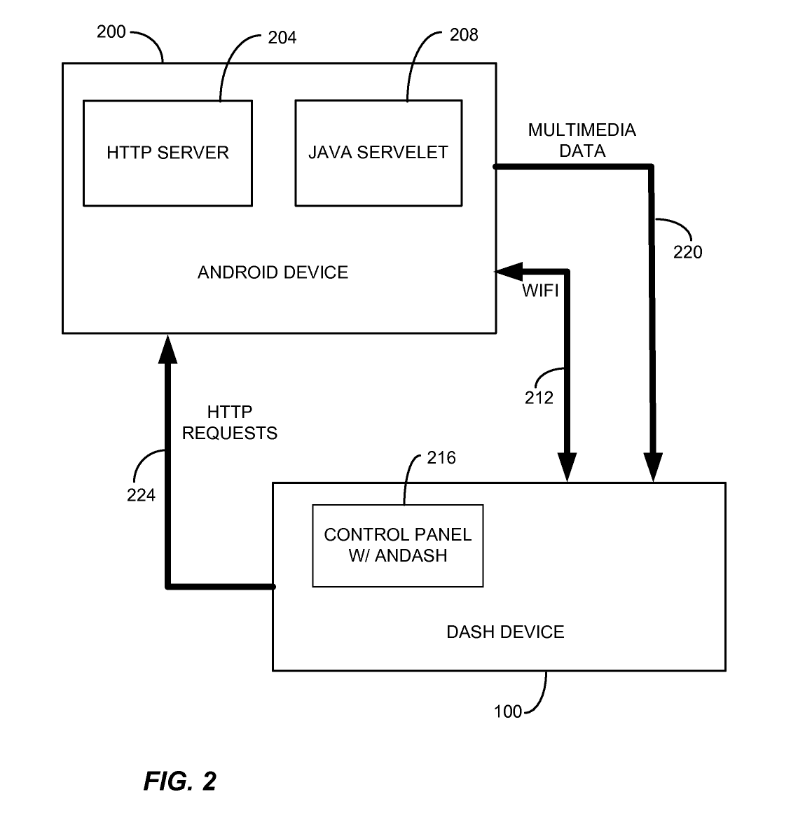

Turning now to FIG. 2, consistent with certain example embodiments this figure presents a configuration diagram for the operational connectivity between the Dash device 100 and each Android capable device 200. In this exemplary configuration, the Android device 200 may have an HTTP capable server 204 and a Java servlet 208 supported by the HTTP capable server 204 and operable on the Android device 200. By way of example, an HTTP server 204 may be an i-jetty web container having the HTTP server capability ported to the Android device 200.

In the exemplary implementation, the Android device 200 has a wireless transceiver and establishes a Wifi connection 212 with the Dash device 100. Once the Wifi connection 212 has been established, the user may activate the application on the Dash device 100. The user may select a category of content presented on the user interface display of the Dash device 100 and then select the AnDash feature 216 icon to initialize the AnDash application. The AnDash feature 216 of the control panel allows the user to input the Internet Protocol (IP) address of the Android device 200, and receives the IP address and establishes a communication channel for the transmission of metadata and multimedia content 220. With the completion of the communication channel 220, the Dash device 100 may transmit HTTP requests 224 to the Android device 200. The Dash device 100 may then continue to transmit HTTP requests 224 as generated by the AnDash 216 function to direct the Android device 200 in the selection and collection of requested information from any network server that is in communication with the Android device 200.

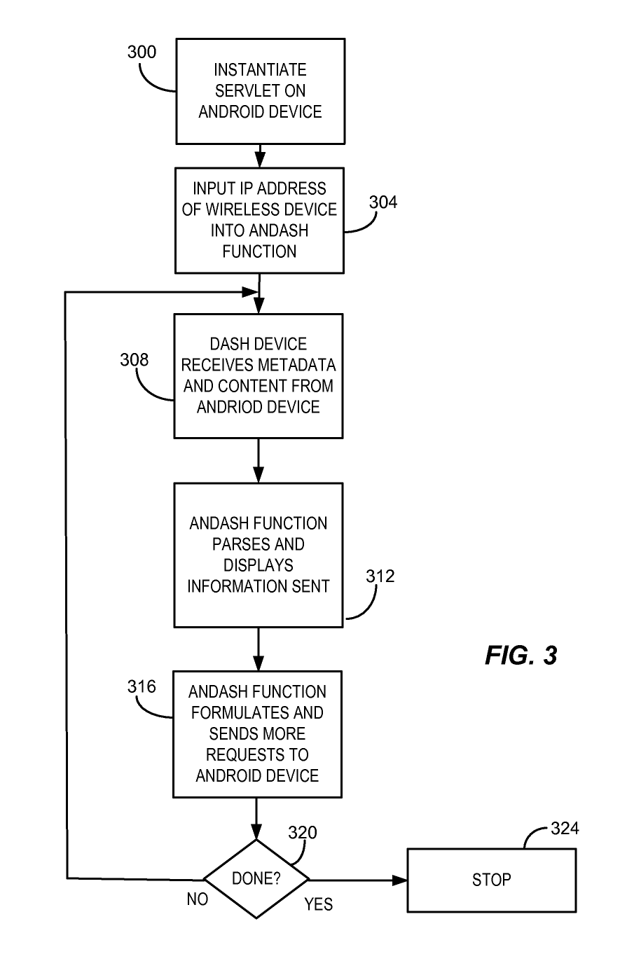

Turning to FIG. 3, this figure presents an exemplary operation flow when accessing media resources through an Android device. At 300, the Android device may activate a servlet to operate with the HTTP server installed on the Android device. After the servlet has been instantiated and an IP address for the Android device has been displayed on the user interface display of the Android device, the IP address has been input into the AnDash function operational on the Dash device, and the communication channel is fully established at 304, the servlet may dynamically generate and send XML files containing multimedia metadata to the Dash device.

At 308, the Dash device receives the multimedia metadata sent from the Android device. The AnDash feature installed within the Dash control panel receives the multimedia metadata and parses the information to extract metadata from the received information. At 312, the metadata may include URL or playback information which may be used by AnDash to display the received multimedia content on the Dash display screen, or, alternately, may be used to generate additional requests and control information to be sent to the Android device.

At 316, the AnDash function may receive requests from the user and formulate new HTTP requests for transmission to the Android device. In this manner, the user may direct the AnDash function to search for and retrieve more information for display and consumption by the user of the Dash device. At 320, the user may signal that more information is desired, or may signal that their use of the Dash device is temporarily at an end. If more information is desired for display, the Dash device may return to 308 and continue to receive and parse content retrieved by the HTTP server in the Android device. If use of the Dash device is to be ended, the system terminates the application at 324.

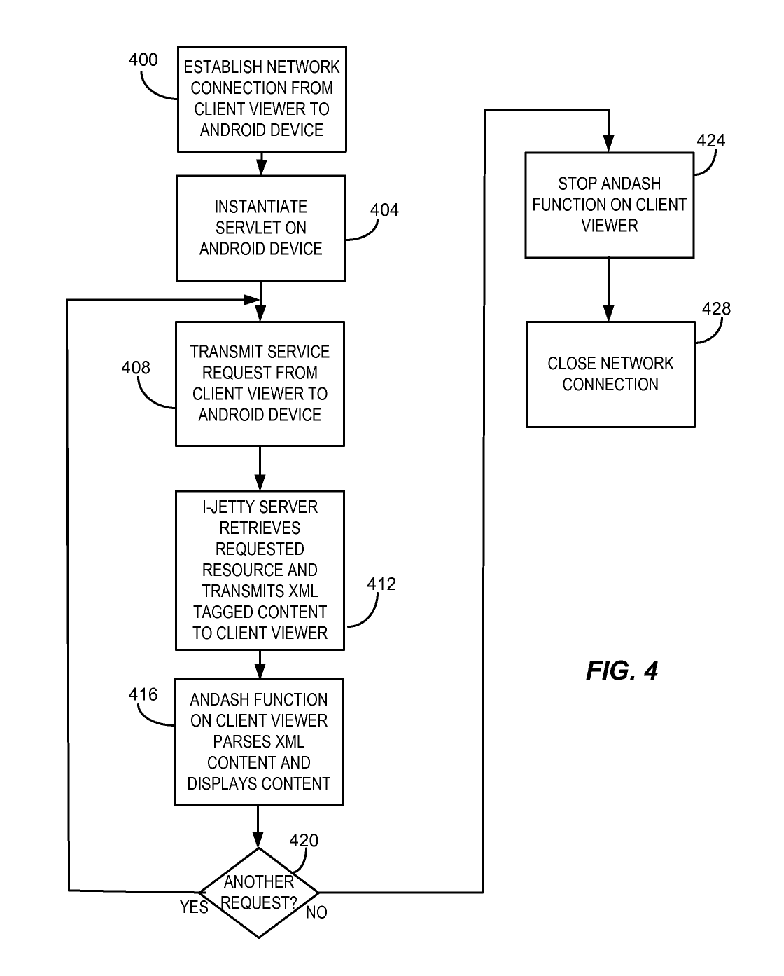

Turning now to FIG. 4, this figure presents an exemplary view of the retrieval of metadata and content for presentation to a user on the display of a mobile device having an Internet viewer client installed on the device. By way of example and not limitation, a Dash Internet viewer, offered by Sony, may be the mobile device with such an installed Internet viewer client. Retrieving images or performing audio sharing of audio files may begin with establishing a wireless network connection between the mobile device, which for purposes of this example is a mobile device operating with an Android operating system, and the Dash Internet viewer at 400. At 404, the Dash Internet viewer may issue a request to instantiate a servlet to operate in an i-jetty HTTP server process on the Android mobile device. The servlet is built within the server on the Android mobile device and will be activated by a request from the AnDash application. At 408, the Dash Internet viewer instantiates an application entitled the AnDash application that enables the Dash Internet viewer to perform as a client of the Android mobile device and utilize the functions and features of the i-jetty HTTP server operating on the Android mobile device. The AnDash application is created using the Flash Lite™ Flash application development tools available from Adobe Systems®. Once operational, the AnDash application transmits a service request for retrieval of an image, video file, sound file, or any other multimedia file that may be available on the Android device.

At 412, the i-jetty server receives the request from the AnDash application on the Dash Internet viewer and retrieves the requested content from the Internet. The content retrieved is formatted as XML tagged content files and transmitted from the Android mobile device to the Dash Internet viewer. At 416, upon receipt of the XML tagged content the AnDash application parses the XML content and formats the parsed content for display on the Dash Internet viewer display. The user may then view or interact with the received content and at 420, may decide to formulate another request for content from the Android device. If additional content is desired, the system returns to step 408 and continues processing.

At 424, if the user of the Dash Internet viewer has determined their content needs have been met, the user may terminate the AnDash function on the Dash Internet viewer, whereupon the Dash Internet viewer may close the network connection at 428.

A process for accessing multimedia resources that includes initiating an i-jetty HTTP server on a first wireless device and establishing a wireless communication connection from the personal Internet interface client to the first wireless device using the IP address on the first wireless device. Once the wireless network connection has been established, the system continues by initiating a function on the personal Internet interface client that parses and displays multimedia content.

The mobile device, which may be a Dash Internet viewer, sends requests to the i-jetty HTTP server on the first wireless device for the collection of multimedia content and metadata, and transmits the multimedia content and metadata from the first wireless device to the personal Internet client through the use of XML files. The Dash Internet viewer operates a service that accesses multimedia resources on the first wireless device where the first wireless device dynamically generates multimedia metadata for transmission to the personal Internet interface client for extraction and display on the mobile device.

A system and method is disclosed for accessing multimedia resources from a network by initiating a servlet on an i-jetty HTTP server, and establishing a wireless communication connection from the personal Internet interface device to the first wireless device using the IP address of the first wireless device.

The system and method operates a service on the personal Internet interface device that accesses multimedia resources on the first wireless device where the first wireless device dynamically generates multimedia metadata for transmission to the personal Internet interface device for extraction and display on the personal Internet interface device.

In the exemplary system and method, the first wireless device is an Android capable device and the personal Internet interface device is a mobile device comprising a Dash Internet viewer client. Content retrieved from the Android capable device may be viewed using a function on the personal Internet interface device that parses and displays multimedia content. The content is retrieved by sending requests to the HTTP server on the first wireless device for the collection of multimedia content and metadata. When available, the multimedia content is transmitted from the first wireless device to the personal Internet device through the use of XML files.

A process for accessing multimedia resources involves initiating an i-jetty HTTP server on a first wireless device (i.e., on one or more processors residing on the first wireless device); establishing a wireless communication connection from a personal Internet interface client to the first wireless device using the IP address of the first wireless device; initiating a function on the personal Internet interface client that parses and displays multimedia content; sending requests to the i-jetty HTTP server on the first wireless device for the collection of multimedia content and metadata; transmitting the multimedia content and metadata from the first wireless device to the personal Internet client through the use of XML files; and operating a service on the personal Internet interface client that accesses multimedia resources on the first wireless device where the first wireless device dynamically generates multimedia metadata for transmission to the personal Internet interface client for extraction and display on the mobile device.

Another method for accessing multimedia resources involves initiating an HTTP server on a first wireless device; establishing a wireless communication connection from the personal Internet interface device to the first wireless device using the IP address of the first wireless device; and operating a service on the personal Internet interface device that accesses multimedia resources on the first wireless device where the first wireless device dynamically generates multimedia metadata for transmission to the personal Internet interface device for extraction and display on the personal Internet interface device.

In certain implementations, the first wireless device comprises an Android capable device. In certain implementations, the first wireless device comprises an Android capable device. In certain implementations, the personal Internet interface device comprises a mobile device comprising a Dash Internet viewer client. In certain implementations, the process involves instantiating a function on the personal Internet interface device that parses and displays multimedia content. In certain implementations, the process involves sending requests to the HTTP server on the first wireless device for the collection of multimedia content and metadata. In certain implementations, the multimedia content is transmitted from the first wireless device to the personal Internet device through the use of XML files. In certain implementations, the HTTP server on the first wireless device is an i-jetty HTTP server.

A example implementation of a system for accessing multimedia resources has at least one servlet operating in an HTTP server on a first wireless device. A wireless communication connection is established from a personal Internet interface device to the first wireless device using the IP address of the first wireless device. A service is operable on the personal Internet interface device that accesses multimedia resources on the first wireless device where the first wireless device dynamically generates multimedia metadata for transmission to the personal Internet interface device for extraction and display on the personal Internet interface device.

In certain implementations, the first wireless device is an Android capable device. In certain implementations, the personal Internet interface device is a mobile device comprising a Dash Internet viewer client. In certain implementations, a function is instantiated on the personal Internet interface device that parses and displays multimedia content. In certain implementations, a request is sent to the HTTP server on the first wireless device for the collection of multimedia content and metadata. In certain implementations, the multimedia content is transmitted from the first wireless device to the personal Internet device through the use of XML files. In certain implementations, the HTTP server on the first wireless device is an i-jetty HTTP server.

A computer readable storage medium or device such as a non-transitory storage medium can store instructions which, when executed on one or more programmed processors to carry out a process for accessing multimedia resources involveing initiating an i-jetty HTTP server on a first wireless device; establishing a wireless communication connection from a personal Internet interface device to the first wireless device using the IP address of the first wireless device; and operating a service on the personal Internet interface device that accesses multimedia resources on the first wireless device where the first wireless device dynamically generates multimedia metadata for transmission to the personal Internet interface device for extraction and display on the personal Internet interface device.

In certain implementations, the first wireless device is an Android capable device. In certain implementations, the personal Internet interface device is a mobile device comprising a Dash Internet viewer client. In certain implementations, a function is instantiated on the personal Internet interface device that parses and displays multimedia content. In certain implementations, a request is sent to the HTTP server on the first wireless device for the collection of multimedia content and metadata. In certain implementations, the multimedia content is transmitted from the first wireless device to the personal Internet device through the use of XML files.

Software and/or firmware embodiments may be implemented using one or more programmed processors executing programming instructions that in certain instances are broadly described above in flow chart form that can be stored on any suitable electronic or computer readable storage medium such as a non-transitory storage medium or device (such as, for example, disc storage, Read Only Memory (ROM) devices, Random Access Memory (RAM) devices, network memory devices, optical storage elements, magnetic storage elements, magneto-optical storage elements, flash memory, core memory and/or other equivalent volatile and non-volatile storage technologies) and/or can be transmitted over any suitable electronic communication medium. However, those skilled in the art will appreciate, upon consideration of the present teaching, that the processes described above can be implemented in any number of variations and in many suitable programming languages without departing from embodiments of the present invention. For example, the order of certain operations carried out can often be varied, additional operations can be added or operations can be deleted without departing from certain embodiments of the invention. Error trapping can be added and/or enhanced and variations can be made in user interface and information presentation without departing from certain embodiments of the present invention. Such variations are contemplated and considered equivalent.

While certain illustrative embodiments have been described, it is evident that many alternatives, modifications, permutations and variations will become apparent to those skilled in the art in light of the foregoing description.

What is claimed is:

1. A process for accessing multimedia resources comprising:
initiating an i-jetty HTTP server on a first wireless device;
establishing a wireless communication connection from a personal Internet interface client to the first wireless device using the IP address of the first wireless device;
initiating a function on the personal Internet interface client that parses and displays multimedia content;
sending requests to the i-jetty HTTP server on the first wireless device for the collection of multimedia content and metadata;
transmitting the multimedia content and metadata from the first wireless device to the personal Internet client through the use of XML files; and
operating a service on the personal Internet interface client that accesses multimedia resources on the first wireless device where the first wireless device dynamically generates multimedia metadata for transmission to the personal Internet interface client for extraction and display on the mobile device.

2. A method for accessing multimedia resources comprising:
initiating an HTTP server on a first wireless device;
establishing a wireless communication connection from the personal Internet interface device to the first wireless device using the IP address of the first wireless device; and
operating a service on the personal Internet interface device that accesses multimedia resources on the first wireless device where the first wireless device dynamically generates multimedia metadata for transmission to the personal Internet interface device for extraction and display on the personal Internet interface device.

3. The method of claim 2, where the first wireless device comprises an Android capable device.

4. The method of claim 2, where the personal Internet interface device comprises a mobile device comprising a Dash Internet viewer client.

5. The method of claim 2 further comprising instantiating a function on the personal Internet interface device that parses and displays multimedia content.

6. The method of claim 2, further comprising sending requests to the HTTP server on the first wireless device for the collection of multimedia content and metadata.

7. The method of claim 2, where the multimedia content is transmitted from the first wireless device to the personal Internet device through the use of XML files.

8. The method of claim 2, where the HTTP server on the first wireless device comprises an i-jetty HTTP server.

9. A system for accessing multimedia resources comprising:
at least one servlet operating in an HTTP server on a first wireless device;
a wireless communication connection established from a personal Internet interface device to the first wireless device using the IP address of the first wireless device; and
a service operable on the personal Internet interface device that accesses multimedia resources on the first wireless device where the first wireless device dynamically generates multimedia metadata for transmission to the personal Internet interface device for extraction and display on the personal Internet interface device.

10. The system of claim 9, where the first wireless device comprises an Android capable device.

11. The system of claim 9, where the personal Internet interface device comprises a mobile device comprising a Dash Internet viewer client.

12. The system of claim 9 further comprising instantiating a function on the personal Internet interface device that parses and displays multimedia content.

13. The system of claim 9, further comprising sending requests to the HTTP server on the first wireless device for the collection of multimedia content and metadata.

14. The system of claim 9, where the multimedia content is transmitted from the first wireless device to the personal Internet device through the use of XML files.

15. The system of claim 9, where the HTTP server on the first wireless device comprises an i-jetty HTTP server.

16. A computer readable storage medium storing instructions which, when executed on a programmed processor, carry out a process for accessing multimedia resources comprising:
initiating an i-jetty HTTP server on a first wireless device;
establishing a wireless communication connection from a personal Internet interface device to the first wireless device using the IP address of the first wireless device; and
operating a service on the personal Internet interface device that accesses multimedia resources on the first wireless device where the first wireless device dynamically generates multimedia metadata for transmission to the personal Internet interface device for extraction and display on the personal Internet interface device.

17. The process of claim 16, where the first wireless device comprises an Android capable device.

18. The process of claim 16, where the personal Internet interface device comprises a mobile device comprising a Dash Internet viewer client.

19. The process of claim 16 further comprising the step of instantiating a function on the personal Internet interface device that parses and displays multimedia content.

20. The process of claim 16, further comprising sending requests to the HTTP server on the first wireless device for the collection of multimedia content and metadata.

21. The process of claim 16, where the multimedia content is transmitted from the first wireless device to the personal Internet device through the use of XML files.
